(19) United States
(12) Patent Application Publication
(10) Pub. No.: US 2014/0283273 A1
(43) Pub. Date: Sep. 25, 2014

(54) BIO BASED MATERIAL AND WETSUIT

(71) Applicant: TECNIQ LLC, Oceanside, CA (US)

(72) Inventor: Robert Falken, Oceanside, CA (US)

(73) Assignee: Tecniq LLC, Oceanside, CA (US)

(21) Appl. No.: 13/849,453

(22) Filed: Mar. 22, 2013

(51) Int. Cl. A41D 13/012; A41D 31/00; B32B 5/26

(52) U.S. Cl. CPC A41D 13/012; B32B 5/26; A41D 31/0038; A41D 2400/24; A41D 2400/10; B32B 2250/02; B32B 2307/72; B32B 2307/732; B32B 2437/00
USPC 2/2.15; 428/220; 428/314.8; 442/221; 428/95

(57) ABSTRACT

A bio-based wetsuit and material is described where ethanol derived from sugar cane is dehydrated into ethylene and polymerized to produce bio-based ethylene propylene diene monomer (EPDM). The bio-based EPDM is mixed with additives and a blowing agent to produce sugar cane derived closed-cell foam for use in wetsuits. Depending on the wetsuit application, the density of the sugar cane derived foam may vary. In many wetsuit applications low densities such as less than 0.25 grams/cubic centimeters are desirable.

### BACKGROUND

This disclosure relates generally to biological based materials having qualities for use in wetsuits and other products. In particular, this document describes sugar cane derived closed-cell foam material.

Surfers, jet skiers, wake boarders, windsurfers, kayakers, whitewater rafters, scuba divers, snorkelers, and fishermen use wetsuits for thermal insulation, comfort and protection during water recreation. Essentially, wetsuits are a form of thermal covering that traps a thin layer of water against the wearer's skin. The thin layer of water combined with an insulating material of the thermal covering allows both to be warmed by body heat.

The insulating material commonly used for wetsuits is polychloroprene, also known as neoprene, a product of synthetic rubber. Unfortunately, polychloroprene has several major disadvantages. These include rubber allergy, high toxicity, and a high carbon footprint, among others. With regard to rubber allergy, 15% of the world's population is allergic to polychloroprene. The American Contact Dermatitis Society labeled neoprene rubber as a common source of mixed dialkyl thioureas, and in 2009 labeled polychloroprene as “Allergen of the Year” as being a primary source of allergic contact dermatitis. As for polychloroprene's toxicity, the material contains heavy metals, formaldehyde, phthalates, lead, and chlorine, which are all known to be harmful to humans. With regard to polychloroprene's carbon footprint, the material resists decomposition until temperature extremes of approximately 800 degrees Celsius, at which point it converts into carbon and omits toxic gas. Unfortunately, landfills and environmental decomposition conditions do not reach the temperature requirements to adequately decompose polychloroprene. This effectively means that polychloroprene will effectively not degrade over time. The process of decomposition is essential for recycling finite matter that occupies the physical space of this planet.

Thus, there exists a clear need for a wetsuit material that is not based on polychloroprene, does not have the allergen potential or the levels of toxicity of polychloroprene, and which has a lower carbon footprint in manufacturing and is more readily decomposable than polychloroprene and conventional materials suitable for such applications as wetsuits or the like.

### SUMMARY

This document describes a bio-based material for use in a wetsuit and other products. In some aspects, the bio-based material is formed of sugar cane derived closed-cell foam material having a low density. In some instances, the density of the closed-cell foam material can be less than 0.25 grams/cubic centimeter.

The bio-based material is free of polychloroprene. In some aspects, the bio-based material is based on an hypoallergenic sugar cane-derived closed-cell foam. The bio-based material described herein insulates as well or better than polychloroprene. As used as a wetsuit material, the bio-based material can withstand tearing, rough handling and severe conditions, yet is inherently flexible. Furthermore, the bio-based material is inert to most chemical agents, and is free of heavy metals, formaldehyde, phthalates, lead, and chlorine, or other toxic agents or compounds.

In one aspect, a wetsuit is disclosed. The wetsuit includes one or more sheets of closed-cell foam formed to cover one or more body parts of a wearer. The closed-cell foam is derived from polymerized sugar cane mixed with at least one foaming agent, and being formed to a density of less than 0.25 grams per cubic centimeter, each of the one or more sheets of closed-cell having a thickness between about 2 millimeters and about 5 millimeters and enabling movement of the one or more body parts of the wearer when covered by the one or more sheets of closed-cell foam.

In another aspect, a method for manufacturing a wetsuit is disclosed. The method includes providing one or more sheets of closed-cell foam formed to cover one or more body parts of a wearer. As described above, the closed-cell foam is derived from polymerized sugar cane mixed with at least one foaming agent. The closed-cell foam is formed to a density of less than 0.25 grams per cubic centimeter. Each of the one or more sheets of closed-cell have a thickness between about 2 millimeters and about 5 millimeters and enabling movement of the one or more body parts of the wearer when covered by the one or more sheets of closed-cell foam. The method further includes assembling the one or more sheets of closed-cell foam into a pattern defining at least a portion of the wetsuit.

The bio-based material can be used for many other applications, such as thermal insulation, bonding, covering, waterproofing, and the like. The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a cross section of the sugar cane derived wetsuit material;

FIG. 2 is a cross section of the sugar cane derived wetsuit material with a fabric covering;

FIG. 3 is a cross section of the sugar cane derived wetsuit material with an inner liner;

FIG. 4 is a cross section of the sugar cane derived wetsuit material with a fabric covering and an inner liner; and

FIG. 5 illustrates a wetsuit using a bio-based wetsuit material.

Like reference symbols in the various drawings indicate like elements.

### DETAILED DESCRIPTION

This document describes a bio-based, naturally-occurring material for use in a wetsuit and other products. In some implementations, the bio-based material is formed at least in part of sugar cane derived closed-cell foam. Sugar cane derived closed-cell foam is considered a generally low modulus, flexible material that can be stretched repeatedly which is an ideal characteristic for the production of the present invention. The bio-based material is free of polychloroprene, and is free of formaldehyde, phthalates, lead, chlorine, or other toxic agents or compounds. In some implementations, the bio-based material is based on a hypoallergenic sugar cane-derived closed-cell foam. Furthermore, the bio-based material is inert to most chemical agents.

The closed-cell foam includes a sugar cane derived compound. In some implementations, the sugar cane derived compound includes dehydrated sugar cane converted into ethylene and polymerized to produce bio-based ethylene propylene diene monomer (EPDM). The foam typically has a bio-based EPDM content of between 40% and 60%, but can also have an EPDM content of less than 40% and greater than 60%. In particular implementations, the bio-based material is further formed with a blowing agent, additives, and/or fillers. For example, a suitable blowing agent can be an exothermic blowing agent paste, such as marketed by Lehmann & Voss & Co. KG. Additives can include oil and chemical resistant materials, for example carbon black such as provided by Cancarb Ldt. under the brand name Thermax®, and can also include pigments, dyes, or thermal enhancement compounds. Fillers can include, for example, calcium carbonate to improve cell structure of the closed cell foam. Other blowing agents, additives, and/or fillers can suitable be used.

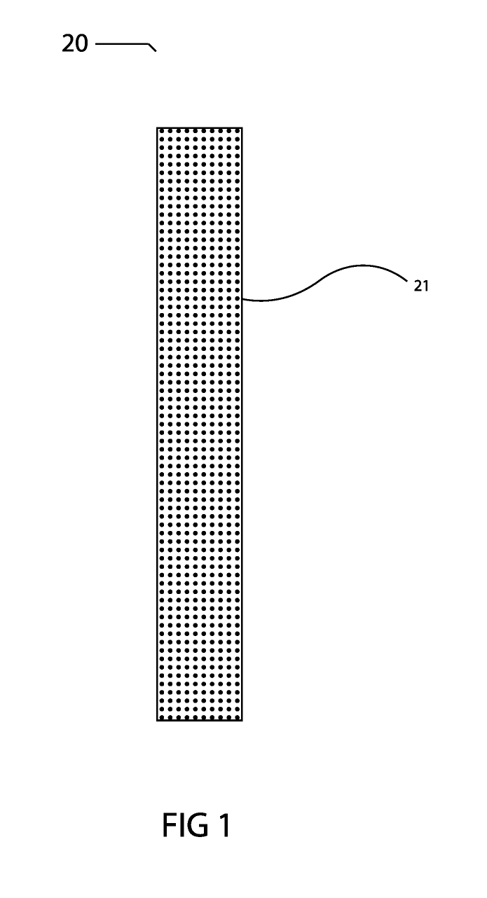

FIG. 1 illustrates a cross-section of a bio-based material 20 for use in wetsuits and other products. In some implementations, the bio-based material 20 is made from sugar cane derived closed-cell foam, 21. The thickness of the bio-based material 20 may vary, depending on a specific application, such as where the wetsuit is used, for how long, etc. In some implementations, the thickness of the bio-based material 20 is sufficient to allow movement by the wearer, yet thermally insulative to protect the wearer. Accordingly, the bio-based material 20 can have thicknesses of substantially two millimeters, three millimeters, four millimeters, or more. In other implementations, the bio-based material 20 can have a thickness of less than two millimeters. Sugar cane derived closed-cell foam may be produced in various colors to further enhance the desirability of a wetsuit formed of the bio-based material 20.

A method of producing a sugar cane derived closed-cell foam includes providing a foamable sugar cane derived bio-based EPDM rubber, such as Keltan ECO™ by LANXESS Buna GmbH, having a suitable hardness value to permit production of soft, low-density foam. The provided foam preferably exhibits compressibility (i.e. load bearing) characteristics that allow the foam to deform easily, yet still resist permanent deformation (compression set) when the load is removed.

In accordance with one method consistent with implementations described herein, a sugar cane derived closed-cell foam formed by incorporating polymerized sugar cane-derived compound chips into a melted mixture with foaming agents, black carbon pigments, or, alternatively, other colored pigments, fillers, plasticizers, and other desired additives. The mixture of polymerized sugar cane-derived compound chips, foaming agents and other fillers are then baked in an oven to expand the mixture into a foam block. Once baked, the foam block is cooled, leaving a large closed-cell foam sponge block of approximately 150 mm thick with a very high independent closed-cell structure. As soon as the sponge block is cured, it is then sliced horizontally into foam sheets of a desired thickness.

In alternative implementations, a sugar cane-derived closed-cell foam is produced by feeding polymerized sugar cane derived compound chips into an extruder, and through the shearing action of one or more screws, melting the compound continuously in the barrel of the extruder. In an intermediate or a mixing section, a blowing agent, usually in a liquid or gaseous state, is continuously injected into the molten compound. In some instances, a chemical blowing agent can dispersed throughout the particulate compound in a powder form before the material is fed to the extruder. In either case, the extruder screw can be designed to mix and dissolve the blowing agent as uniformly as possible in the molten compound. Thorough, uniform mixing is essential to the production of high quality foam. The resultant mixture is maintained under carefully controlled temperatures and pressures within the extruder in order to prevent the volatilization of the blowing agent.

The molten mixture is then forced through a die, and the material undergoes decompression to atmospheric pressure so that the blowing agent separates within the body of material as it bubbles. If the temperature is too high, there is overexpansion and the cells rupture. If the temperature is too low, there is incomplete expansion, resulting in low quality foam. In many instances, the temperature window between overexpansion and underexpansion is only a few degrees Fahrenheit.

The sugar cane derived closed-cell foam may contain additives, if necessary for a certain application of a wetsuit formed thereof. The additives can be provided in an amount by which the mechanical strength and the flexibility are not affected adversely, and can include an antistatic agent, weatherability-imparting agent, UV absorber, glidant, antibacterial agent, antifungal agent, tackifier, softener, plasticizer, filler such as titanium oxide, carbon black, dry silica, wet silica, aramid fiber, mica, calcium carbonate, potassium titanate whisker, talc, barium sulfate, and the like.

Various densities of sugar cane derived foam that has been expanded into a closed-cell structure may be used to make a wetsuit of the bio-based material described herein. Low densities, for example, less than about 0.25 grams/cubic centimeter are well suited for making the wetsuit. Other densities may also be used.

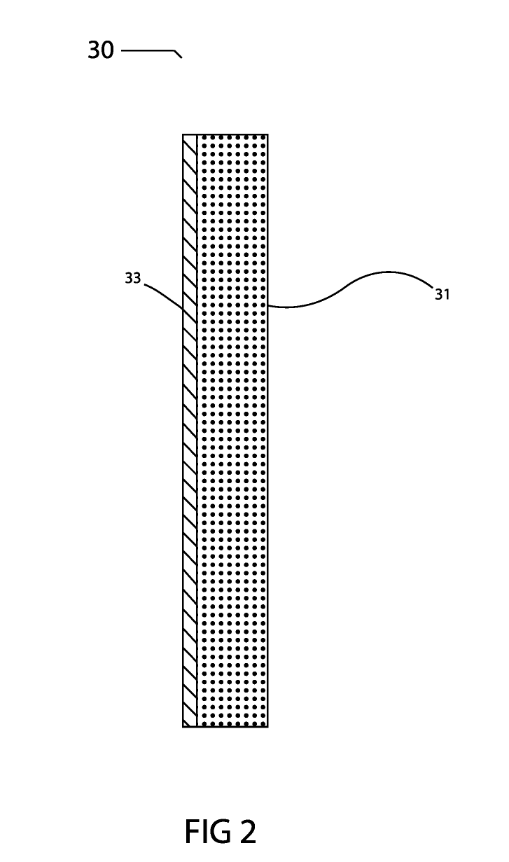

FIG. 2 illustrates a cross section of a sugar cane derived closed-cell foam 31 having a fabric covering 33. The fabric covering 33 can be used to further strengthen and reinforce the sugar cane derived closed-cell foam 31. In some implementations, the fabric covering 33 is bonded to the sugar cane derived closed-cell foam 31 using an adhesive, a heat process, a cold process, or the like. The fabric covering 33 can be formed of a woven polypropylene, woven nylon, aramid fiber, Lycra, spandex, or the like.

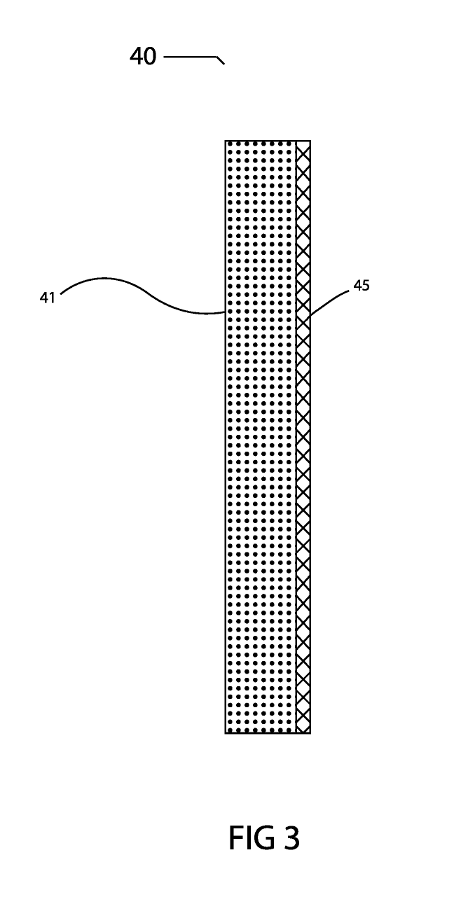

FIG. 3 illustrates a cross section of a wetsuit material 40 having a sugar cane derived closed-cell foam 41 and an inner liner 45. The inner liner 45 can be used to provide added comfort to the user. In some implementations, the inner liner 45 is bonded to the sugar cane derived closed-cell foam 41 using an adhesive, a heat process, a cold process, or the like. In some exemplary implementations, the inner liner 45 can include a fleece polypropylene, spun nylon, jersey, or a low friction coating such as an SCS coating, Lycra, spandex, or the like.

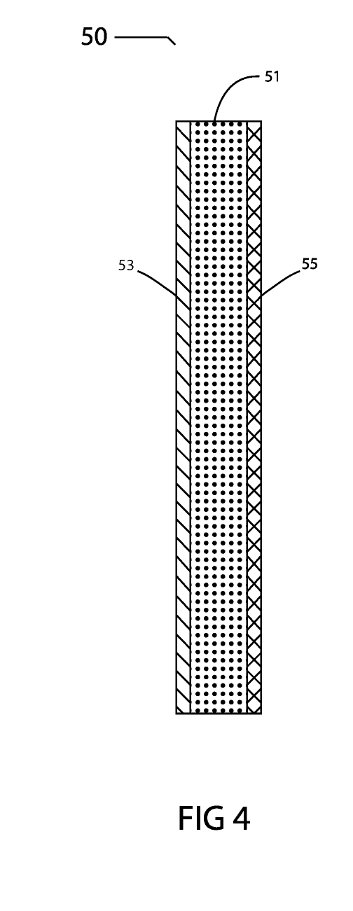

FIG. 4 illustrates a cross section of a wetsuit material 50 having an inner liner 55 and a fabric covering 53 applied to opposite sides of a sugar cane derived closed-cell foam 51. The inner liner 55 can be bonded to the sugar cane derived closed-cell foam 51 using an adhesive, a heat process, a cold process, or the like. Such inner liner may be a fleece polypropylene, spun nylon, jersey, a low friction coating such as an SCS coating. Lycra, spandex, or the like. In a similar fashion, the fabric covering 53 can be bonded to the sugar cane derived closed-cell foam 51 using an adhesive, a heat process, a cold process, or the like. The fabric covering 53 may be a woven polypropylene, woven nylon, aramid fiber, Lycra, spandex, or the like. In alternative implementations, other materials may be placed on either side of the sugar cane derived closed-cell foam 51 to enhance performance, and/or to achieve desirable characteristics of the wetsuit material 50.

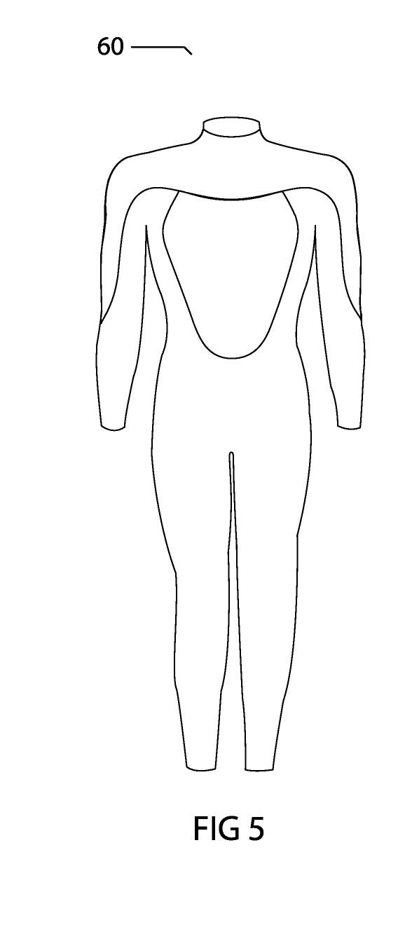

FIG. 5 depicts a bio-based wetsuit 60 in accordance with implementations described herein. The bio-based wetsuit 60 can be formed of any style and size, for example and without limitation, a short sleeved wetsuit, short john, wetsuit top, waders, or the like. The bio-based wetsuit 60 can be formed of sheets of sugar cane derived closed-cell foam, as described above, and constructed by automated machine cutting and seam bonding or hand cutting, tailoring and seam bonding. Automated or hand methods of assembly can be used to fabricated the sheets into the bio-based wetsuits 60.

In accordance with alternative implementations, the sugar cane derived closed-cell foam material is cut to various patterned pieces, the pieces are joined together using a technique such as gluing or double gluing (glue is applied to both sides of each piece of material to be joined together), the joined and glued together pieces may optionally be nipped (a technique where pressure is applied to the joined seams), a piece of material such as heat welded tape made from a material such as stretch nylon is then placed on the inside of the seam and glued in place, the pieces are then blind stitched from one or both sides, and optionally the seams are covered with a material such as heat welded tape or the like. To complete the bio-based wetsuit 60, a zipper or zippers are added along with logos, and the like. The steps heretofore described may be modified or adapted to various situations, materials, and wetsuit designs.

A wetsuit as described above, formed of a bio-based material, can insulate a wearer as well or better than a polychloroprene-based wetsuit. Further, the wetsuit formed of the bio-based material can withstand tearing, rough handling and severe conditions, yet is inherently flexible.

Although a few embodiments have been described in detail above, other modifications are possible. Other embodiments may be within the scope of the following claims.

1. A wetsuit comprising:
one or more sheets of closed-cell foam formed to cover one or more body parts of a wearer, the closed-cell foam being derived from polymerized sugar cane mixed with at least one foaming agent, the closed-cell foam being formed to a density of less than 0.25 grams per cubic centimeter, each of the one or more sheets of closed-cell having a thickness between about 2 millimeters and about 5 millimeters and enabling movement of the one or more body parts of the wearer when covered by the one or more sheets of closed-cell foam.

2. The wetsuit in accordance with claim 1, further comprising an outer fabric attached to and covering at least a portion of an outer surface of at least one of the one or more sheets of closed-cell foam.

3. The wetsuit in accordance with claim 2, wherein the outer fabric includes woven nylon.

4. The wetsuit in accordance with claim 2, wherein the outer fabric includes aramid fiber.

5. The wetsuit in accordance with claim 2, wherein the outer fabric includes spandex.

6. The wetsuit in accordance with claim 2, wherein the outer fabric includes woven polypropylene.

7. The wetsuit in accordance with claim 1, further comprising an inner liner attached to and covering at least a portion of an inner surface of at least one of the one or more sheets of closed-cell foam.

8. The wetsuit in accordance with claim 7, wherein the inner liner includes spun nylon.

9. The wetsuit in accordance with claim 7, wherein the inner liner includes polypropylene fleece.

10. A material comprising closed-cell foam derived from polymerized sugar cane mixed with at least one foaming agent, the closed-cell foam being formed to a density of less than 0.25 grams per cubic centimeter, each of the one or more sheets of closed-cell having a thickness between about 2 millimeters and about 5 millimeters and enabling movement of the one or more body parts of the wearer when covered by the one or more sheets of closed-cell foam.

11. The material in accordance with claim 10, further comprising an outer fabric attached to and covering at least a portion of an outer surface of the closed-cell foam.

12. The material in accordance with claim 11, wherein the outer fabric includes woven nylon.

13. The material in accordance with claim 11, wherein the outer fabric includes aramid fiber.

14. The material in accordance with claim 11 wherein the outer fabric includes spandex.

15. The material in accordance with claim 11, wherein the outer fabric includes woven polypropylene.

16. The material in accordance with claim 10, further comprising an inner liner attached to and covering at least a portion of an inner surface of the closed-cell foam.

17. The material in accordance with claim 16, wherein the inner liner includes fleece polypropylene.

18. The material in accordance with claim 16, wherein the inner liner includes spun nylon.

19. A method for manufacturing a wetsuit, the method comprising:
providing one or more sheets of closed-cell foam formed to cover one or more body parts of a wearer, the closed-cell foam being derived from polymerized sugar cane mixed with at least one foaming agent, the closed-cell foam being formed to a density of less than 0.25 grams per cubic centimeter, each of the one or more sheets of closed-cell having a thickness between about 2 millimeters and about 5 millimeters and enabling movement of the one or more body parts of the wearer when covered by the one or more sheets of closed-cell foam; and
assembling the one or more sheets of closed-cell foam into a pattern defining at least a portion of the wetsuit.

20. The method in accordance with claim 19, wherein providing the one or more sheets of the closed-cell foam includes cutting the closed-cell foam into the one or more sheets to cover the one or more body parts of the wearer.
